(19) United States
(12) Patent Application Publication
(10) Pub. No.: US 2024/0330314 A1
(43) Pub. Date: Oct. 3, 2024

(54) AI-Powered System and Method for Centralized Management of Non-Personal Accounts in Hybrid IT Environments

(71) Applicant: Tejvir ., Amsterdam (NL)

(72) Inventor: Tejvir ., Amsterdam (NL)

(21) Appl. No.: 18/656,638

(22) Filed: May 7, 2024

(51) Int. Cl. G06F 16/25; G06F 16/215

(52) U.S. Cl. CPC G06F 16/254; G06F 16/215

(57) ABSTRACT

The present invention relates to a system and method for the discovery, centralized oversight, and artificial intelligence (AI)-powered management of non-personal accounts (NPAs) within hybrid IT environments. The system addresses the challenges of managing NPAs across diverse infrastructures, including on-premise systems, multiple cloud providers, and legacy environments. It provides a comprehensive solution that enhances security and compliance by offering a unified view of NPA usage and proactive insights. The invention comprises an orchestration engine for coordinating the management process, a cross-platform discovery engine for extracting NPA data, an ETL pipeline for secure data transfer, a centralized data warehouse for data normalization and integration, an AI-powered insights engine for analysis and recommendations, and a visualization layer for presenting information in a user-friendly format. The system integrates with existing identity and lifecycle management tools, extending their functionality to include NPA management.

### CROSS-REFERENCE TO RELATED APPLICATIONS

No related applications are previously filed.

### FIELD OF THE INVENTION

The present invention pertains to the field of computer security, specifically to a system and method for the discovery, management, and oversight of non-personal accounts (NPAs) within hybrid IT environments. The invention encompasses advancements in identity and access management (IAM), artificial intelligence (AI), data management, and analytics. It introduces a novel approach to centralized oversight and AI-powered management of NPAs, addressing the challenges posed by diverse and complex IT infrastructures that include on-premise systems, multiple cloud providers, and legacy environments.

### BACKGROUND OF THE INVENTION

Historically, managing NPAs (non-personal accounts used by machines, applications, or services) within these heterogeneous environments has posed several critical challenges. Firstly, organizations lack centralized visibility into NPA usage and compliance risks across their IT landscape. Without a unified view, they are vulnerable to security breaches and ill-prepared for audits. Secondly, existing identity management solutions primarily focus on personal accounts, leaving NPAs unmanaged and creating blind spots in diverse infrastructures. This siloed management approach fails to address the unique requirements of NPA governance.

Furthermore, traditional NPA management processes are manual and reactive, relying on periodic audits rather than proactive, insights-driven remediation. This reactive approach increases compliance risks and exposes organizations to potential security threats. The limitations of existing solutions are evident in their platform-specific focus and secret vault-centric discovery, which fail to provide the broader insights necessary for optimization and compliance across diverse IT environments.

Consequently, there is a clear need for a new approach that can offer centralized oversight and proactive insights for NPA management, enabling organizations to streamline compliance processes and proactively mitigate security risks across their IT landscape. Existing solutions have proven inadequate in addressing the complexities of NPA management in hybrid IT environments, necessitating a comprehensive system and methodology to address this critical gap.

The proposed invention aims to address these challenges by introducing a comprehensive system and methodology that encompasses an orchestration engine, cross-platform discovery engine, ETL (Extract, Transform, Load) pipeline, centralized data warehouse, AI-powered insights engine, and visualization layer. This system is designed to provide organizations with the tools they need to achieve centralized NPA oversight, streamline compliance processes, and proactively mitigate security risks across their IT landscape, thereby addressing the limitations of existing solutions and meeting the pressing needs of modern organizations operating in complex, hybrid IT environments.

These and many other problems have been long identified. Different solutions to the problems have been tried. However there exists no comprehensive solution to all the above problems. Therefore, the objective of the present invention overcomes the limitations and drawbacks from the prior art. To achieve above and other objectives, the present invention anticipates a new and entirely different system that resolves the limitations and drawbacks.

The present invention overcomes the limitations of existing NPA management approaches by providing a comprehensive, AI-driven system that offers centralized visibility, cross-platform discovery, automated data normalization, and proactive insights generation tailored for hybrid IT environments. Unlike fragmented or platform-specific solutions, the invention introduces a holistic methodology that addresses the entire lifecycle of NPA management, from discovery and enrichment to AI-powered risk assessments, compliance optimization, and root cause analysis. By seamlessly integrating with external data sources such as configuration management databases and vault solutions, the system fosters a contextually rich understanding of the organization's NPA landscape, enabling proactive mitigation of security risks and streamlined compliance processes. Moreover, the invention's AI-powered insights engine, employing advanced techniques like large language models, sets it apart from traditional reactive auditing tools, empowering organizations to shift towards a proactive, data-driven approach to NPA governance. This unprecedented level of centralized oversight, cross-platform compatibility, and AI-driven intelligence represents a significant advancement over existing solutions, equipping organizations with the tools necessary to effectively manage the complexities of NPAs in today's hybrid IT environments.

### SUMMARY OF THE INVENTION

Embodiments of the invention solve the above-mentioned problems by providing a comprehensive system and methodology for the discovery, centralized oversight, and artificial intelligence (AI)-powered management of NPAs across hybrid IT environments. The invention addresses the limitations of existing tools by offering a solution that is not confined to specific platforms or vault solutions, thereby enabling organizations to achieve a unified view of NPA usage and compliance risks.

The system's architecture includes an Orchestration Engine, Cross-Platform Discovery Engine, ETL Pipeline, Centralized Data Warehouse, AI-powered Insights Engine, and Visualization Layer. These components interact seamlessly to deliver a complete NPA management solution. The Cross-Platform Discovery Engine employs environment-specific methods to extract NPA data, ensuring the capture of all mandatory attributes. The ETL Pipeline securely transfers this data, while the Data Warehouse applies normalization and de-duplication logic, integrating with configuration management database and vault solutions for enriched NPA profiles.

The AI-powered Insights Engine is a cornerstone of the invention, utilizing a confidential large language model to analyze normalized NPA data and generate actionable insights. This engine produces security risk assessments, proactive recommendations for account management, compliance optimization guidance, and root cause analysis of non-compliance issues.

The Visualization Layer presents this information through tailored dashboards, displaying key performance indicators (KPIs) and compliance metrics in a user-friendly interface. The system also integrates with existing Identity and Lifecycle Management tools, enhancing their functionality to include NPA management.

This summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following detailed description and figures.

### BRIEF DESCRIPTION OF THE DRAWINGS

The prior and other objects of this invention, the various features thereof, as well as the invention itself, may be more fully understood from the following description, when read together with the accompanying drawings in which:

FIG. 1 provides a stepwise illustration of AI-powered system for centralized management of non-personal accounts in hybrid IT environments.

### DETAILED DESCRIPTION OF PREFERRED EMBODIMENT(S)

The following detailed description is intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, embodiments of the invention can include a variety of combinations and/or integrations of the embodiments described herein.

The present invention is a comprehensive system and method for managing NPAs within hybrid IT environments. It addresses the significant challenges organizations face due to the complexity of their IT infrastructures, which often comprise a mix of on-premise systems, multiple cloud providers, and legacy environments. The invention provides a centralized platform that encompasses several core components working in unison to facilitate end-to-end NPA management.

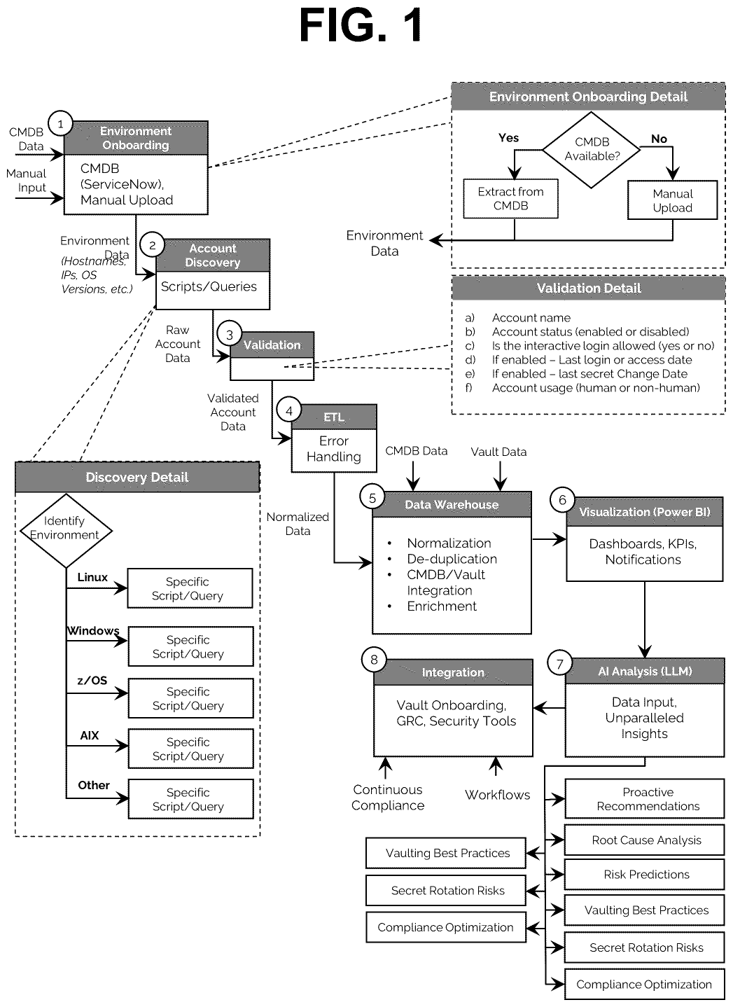

A preferred embodiment of the present invention is a comprehensive system for managing NPAs within a hybrid IT environment, as illustrated in FIG. 1. In the preferred embodiment, the system comprises an Orchestration Engine, a Cross-Platform Discovery Engine, an ETL Pipeline, a Centralized Data Warehouse, an AI-powered Insights Engine, and a Visualization Layer. The Orchestration Engine acts as the central control system, coordinating the various components and facilitating the overall management of NPAs. It enables the scheduling and execution of discovery processes, data transformations, and insights generation. The Orchestration Engine may be built using a combination of technologies such as Python, Java, or enterprise workflow management tools.

The Cross-Platform Discovery Engine is a critical component responsible for extracting NPA data and mandatory attributes from diverse platforms within the organization's IT landscape. This engine employs a combination of environment-specific methods, including but not limited to OS-specific scripts, platform connectors, and relevant APIs. For instance, in a Unix/Linux environment, the Discovery Engine may leverage scripts that parse files such as/etc/passwd to identify NPAs and their associated attributes. In a Microsoft Active Directory environment, the engine may utilize LDAP queries and PowerShell scripts to extract the required information. For cloud environments like AWS, Azure, or GCP, the engine may interface with the respective cloud provider APIs to discover and retrieve NPA data. The Discovery Engine ensures the capture of all mandatory attributes for each NPA, such as account name, status (enabled/disabled), interactive login permission, and usage type (human/non-human). The captured data is then securely transferred to the ETL Pipeline for further processing.

The ETL (Extract, Transform, Load) Pipeline is responsible for securely transferring NPA data from the source environments to the Centralized Data Warehouse. This component employs secure protocols and encryption methods to safeguard the data during transit. Additionally, the ETL Pipeline performs any necessary preliminary data transformations to prepare the data for analysis. Such transformations may include formatting adjustments, data cleansing, and initial normalization tasks.

The Centralized Data Warehouse serves as the central repository for all NPA data collected from the various sources within the organization's IT infrastructure. This component employs robust normalization techniques to standardize NPA data from disparate sources, ensuring consistency for analysis. Furthermore, the Data Warehouse employs de-duplication logic to identify and eliminate duplicate or redundant NPA entries accurately. This process ensures that the data stored in the warehouse is accurate, complete, and free from redundancies.

In one embodiment, the Data Warehouse integrates with the organization's Configuration Management Database (CMDB) to enrich NPA profiles with contextual information, fostering a holistic view of the IT landscape. This integration may involve leveraging APIs or dedicated connectors to retrieve relevant data from the CMDB and associating it with the corresponding NPA entries. Additionally, the Data Warehouse may integrate with existing vault solutions, such as CyberArk, HashiCorp Vault, or other secret management platforms. This integration enhances NPA profiles with relevant secret management data, further strengthening security insights and enabling the optimization of vaulting strategies.

A core innovation of the present invention is the AI-powered Insights Engine, which leverages advanced artificial intelligence techniques to generate actionable insights and recommendations for effective NPA management. In the preferred embodiment, the Insights Engine employs a large language model (LLM) to analyze the normalized NPA data stored in the Centralized Data Warehouse. The specific LLM architecture and training data utilized remain confidential to protect the intellectual property and competitive advantage of the invention. The AI model is continuously improved through established feedback mechanisms, ensuring that its accuracy and performance are maintained and enhanced over time.

The Insights Engine produces various outputs to assist organizations in managing their NPAs effectively. Firstly, it provides Security Risk Assessments by analyzing the NPA data to identify potential security risks, such as misconfigured or vulnerable accounts. It presents risk assessments and prioritizes remediation efforts based on the organization's risk tolerance and security policies. Secondly, the engine suggests Proactive Recommendations for account management, including recommendations for account configurations, access controls, and vaulting strategies. These recommendations are tailored to the organization's specific environment and aim to optimize security and compliance posture.

Additionally, the Insights Engine provides compliance optimization guidance by analyzing the NPA data in the context of relevant security regulations and standards, such as the Digital Operational Resilience Act (DORA), Sarbanes-Oxley Act (SOX), Health Insurance Portability and Accountability Act (HIPAA), Payment Card Industry Data Security Standard (PCI DSS), and others. It offers guidance on compliance optimization strategies, helping organizations meet the requirements of these regulations more effectively. In cases of non-compliance or security incidents, the Insights Engine performs Root Cause Analysis by identifying underlying patterns and issues that may have contributed to the observed issues. This analysis aids in implementing preventive measures and strengthening the overall security posture.

The Visualization Layer presents the insights and recommendations generated by the system in a user-friendly and actionable format. This component includes tailored dashboards and interfaces that display KPIs based on the organization's risk tolerance, as well as compliance metrics and other relevant information. In one embodiment, the Visualization Layer integrates with existing Identity and Lifecycle Management (ILM) tools, extending their functionality to encompass NPA management. This integration allows organizations to leverage their existing investments in IAM solutions while benefiting from the advanced NPA management capabilities provided by the present invention. The user interfaces may include features such as interactive visualizations, customizable reporting, and alert mechanisms to ensure that stakeholders are promptly notified of critical issues or changes in the NPA landscape.

While the preferred embodiment describes a comprehensive system for NPA management, alternative embodiments may include variations or subsets of the described components, tailored to specific organizational requirements or deployment scenarios. For example, in one alternative embodiment, the Cross-Platform Discovery Engine may be designed to support a specific subset of platforms or environments, such as cloud-only or on-premise-only deployments. In another embodiment, the AI-powered Insights Engine may be replaced or complemented by rule-based engines or expert systems, depending on the organization's preferences and requirements.

Furthermore, the integration points with external systems, such as CMDB and vault solutions, may be optional or configurable, allowing organizations to leverage the invention with or without these integrations based on their existing IT infrastructure. The specific implementation details, such as the programming languages, frameworks, and tools used for each component, may vary across embodiments while adhering to the core principles and functionalities described herein.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular examples of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

### ABBREVIATIONS

Artificial Intelligence (AI)
Centralized Data Warehouse (CDW)
Large Language Model (LLM)
Configuration Management Database (CMDB)
Cross-Platform Discovery Engine (CPDE)
Digital Operational Resilience Act (DORA)
Extract, Transform, Load (ETL)
Health Insurance Portability and Accountability Act (HIPAA)
Identity and Access Management (IAM)
Identity and Lifecycle Management (ILM)
Information Technology (IT)
Key Performance Indicators (KPIs)
Non-Personal Accounts (NPAs)
Orchestration Engine (OE)
Payment Card Industry Data Security Standard (PCI DSS)
Sarbanes-Oxley Act (SOX)

Having fully and clearly described the invention so as to enable one having skill in the art to understand and practice the same, the invention claimed is:

1. A system for managing non-personal accounts (NPAs) within a hybrid IT environment comprising:
a) an orchestration engine configured to coordinate and control the overall NPA management process;
b) a cross-platform discovery engine configured to extract NPA data and attributes from diverse platforms within the hybrid IT environment, utilizing environment-specific methods;
c) an extract, transform, load (ETL) pipeline configured to securely transfer the extracted NPA data and perform data transformations;
d) a centralized data warehouse configured to store and normalize the NPA data from disparate sources, employ de-duplication logic, and integrate with external data sources;
e) an AI-powered insights engine configured to analyze the normalized NPA data and generate insights, recommendations, and compliance guidance; and
f) a visualization layer configured to present the generated insights and recommendations in a user-friendly format.

2. The system of claim 1, wherein the orchestration engine is further configured to schedule and execute the discovery processes, data transformations, and insights generation.

3. The system of claim 1, wherein the cross-platform discovery engine is further configured to utilize OS-specific scripts, platform connectors, and APIs to extract NPA data and mandatory attributes from diverse environments, including on-premise systems, cloud providers, and legacy environments.

4. The system of claim 1, wherein the ETL pipeline is further configured to employ secure protocols and encryption methods to safeguard the transfer of NPA data from source environments to the centralized data warehouse.

5. The system of claim 1, wherein the centralized data warehouse is further configured to integrate with a configuration management database to enrich NPA profiles with contextual information.

6. The system of claim 1, wherein the centralized data warehouse is further configured to integrate with one or more vault solutions to enhance NPA profiles with relevant secret management data.

7. The system of claim 1, wherein the AI-powered insights engine is further configured to employ a large language model (LLM) to analyze the normalized NPA data and generate insights.

8. The system of claim 7, wherein the AI-powered insights engine is further configured to generate security risk assessments by identifying misconfigured or vulnerable NPAs based on the organization's risk tolerance and security policies.

9. The system of claim 7, wherein the AI-powered insights engine is further configured to generate proactive recommendations for account management, including account configurations, access controls, and vaulting strategies tailored to the organization's specific environment.

10. The system of claim 7, wherein the AI-powered insights engine is further configured to provide compliance optimization guidance by analyzing the NPA data in the context of relevant security regulations and standards.

11. The system of claim 7, wherein the AI-powered insights engine is further configured to perform root cause analysis of non-compliance or security incidents by identifying underlying patterns and issues contributing to the observed issues.

12. The system of claim 1, wherein the visualization layer is further configured to integrate with existing identity and lifecycle management (ILM) tools, extending their functionality to encompass NPA management.

13. A method for managing non-personal accounts (NPAs) within a hybrid IT environment, comprising:
a) extracting NPA data and attributes from diverse platforms within the hybrid IT environment utilizing environment-specific methods;
b) securely transferring and transforming the extracted NPA data;
c) storing and normalizing the NPA data from disparate sources in a centralized data warehouse, employing de-duplication logic, and integrating with external data sources;
d) analyzing the normalized NPA data using an AI-powered insights engine to generate insights, recommendations, and compliance guidance; and
e) presenting the generated insights and recommendations in a user-friendly format.

14. The method of claim 13, further comprising scheduling and executing the discovery processes, data transformations, and insights generation using an orchestration engine.

15. The method of claim 13, wherein extracting NPA data and attributes comprises utilizing OS-specific scripts, platform connectors, and APIs to extract NPA data and mandatory attributes from diverse environments, including on-premise systems, cloud providers, and legacy environments.

16. The method of claim 13, wherein securely transferring and transforming the extracted NPA data comprises employing secure protocols and encryption methods to safeguard the transfer of NPA data from source environments to the centralized data warehouse, and performing preliminary data transformations.

17. The method of claim 13, wherein storing and normalizing the NPA data comprises integrating with a configuration management database to enrich NPA profiles with contextual information.

18. The method of claim 13, wherein storing and normalizing the NPA data comprises integrating with one or more vault solutions to enhance NPA profiles with relevant secret management data.

19. The method of claim 13, wherein analyzing the normalized NPA data using an AI-powered insights engine comprises employing a large language model (LLM) to generate insights.

20. The method of claim 19, wherein generating insights comprises:
a) generating security risk assessments by identifying misconfigured or vulnerable NPAs based on the organization's risk tolerance and security policies;
b) generating proactive recommendations for account management, including account configurations, access controls, and vaulting strategies tailored to the organization's specific environment;
c) providing compliance optimization guidance by analyzing the NPA data in the context of relevant security regulations and standards; and
d) performing root cause analysis of non-compliance or security incidents by identifying underlying patterns and issues contributing to the observed issues.

21. The method of claim 13, wherein presenting the generated insights and recommendations comprises integrating with existing identity and lifecycle management (ILM) tools, extending their functionality to encompass NPA management.

22. A non-transitory computer-readable medium storing instructions that, when executed by a processor, cause the processor to perform a method for managing non-personal accounts (NPAs) within a hybrid IT environment, the method comprising:
a) extracting NPA data and attributes from diverse platforms within the hybrid IT environment utilizing environment-specific methods;
b) securely transferring and transforming the extracted NPA data;
c) storing and normalizing the NPA data from disparate sources in a centralized data warehouse, employing de-duplication logic, and integrating with external data sources;
d) analyzing the normalized NPA data using an AI-powered insights engine to generate insights, recommendations, and compliance guidance; and
e) presenting the generated insights and recommendations in a user-friendly format.
